(19) United States
(12) Patent Application Publication
(10) Pub. No.: US 2010/0237552 A1
(43) Pub. Date: Sep. 23, 2010

(54) DEVICE FOR POSITIONING WORKPIECE

(75) Inventor: CHIH-CHEN LAI, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/722,509

(22) Filed: Mar. 11, 2010

(30) Foreign Application Priority Data
Mar. 18, 2009 (CN) 200910300943.5

(51) Int. Cl. B23Q 3/00

(52) U.S. Cl. 269/289 R

(57) ABSTRACT

A positioning device with a positioning face, which comprises a combination of concaves provided on the positioning face. The boundaries of each of concaves intersect to boundaries of other concaves adjacent thereto. A positioning section is provided on the positioning face, and the periphery of the positioning section is defined by the interaction of boundaries of the combination of concaves.

### BACKGROUND

1. Technical Field

The present application is related to precision machining, and especially to a positioning fixture used in precision machining.

2. Description of Related Art

In precision machining, a positioning fixture is commonly provided on a lathe for accurate positioning of a workpiece. A concave is usually provided on the positioning fixture for labeling positioning of the workpiece. The workpiece is partially or totally received into a concave, provided on an inner side of the positioning fixture to complete the position. If precision of positioning is required, width and depth of the concave should be small enough. However, when depth and width of the concave is too small, difficulty for technicians operating position will be highly increased. When depth and width of the concave are too large, position error will be caused correspondingly due to mismatch between the workpiece and the concave, and machining precision will be highly impaired. Therefore, a positioning fixture that provides high position precision to machining is desired.

### BRIEF DESCRIPTION OF THE DRAWINGS

FIG. 1 is a schematic view showing a positioning device according to a first embodiment.

FIG. 2 is a schematic view showing a positioning device according to a second embodiment.

FIG. 3 is a schematic view showing a positioning device according to a third embodiment.

FIG. 4 is a schematic perspective view of a positioning section of the positioning device in FIG. 1.

FIG. 5 is a schematic perspective view of a positioning section of the positioning device in FIG. 2.

### DETAILED DESCRIPTION

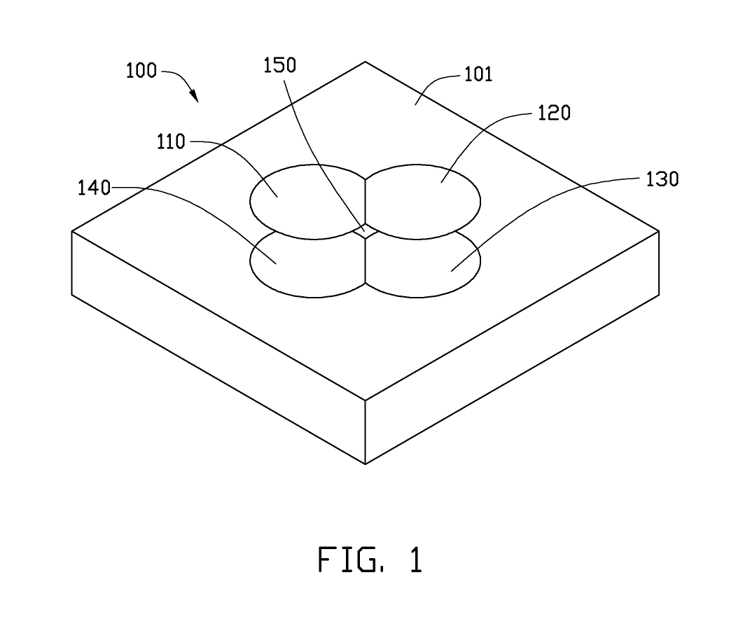

Referring to FIG. 1, a positioning device 100 is embodied as a plate, and the positioning device 100 comprises a positioning surface 101.

A plurality of combined concaves is defined in the center of the positioning surface 101. The concaves comprise a first concave 110, a second concave 120, a third concave 130, and a fourth concave 140 symmetrically and radially arranged about the center of the positioning surface 101. The first concave 110, the second concave 120, the third concave 130, and the fourth concave 140 overlap one another. A protruding positioning section 150 is formed among the overlapping portions of the first through fourth concaves 110, 120, 130, 140 in the center of the positioning surface 101.

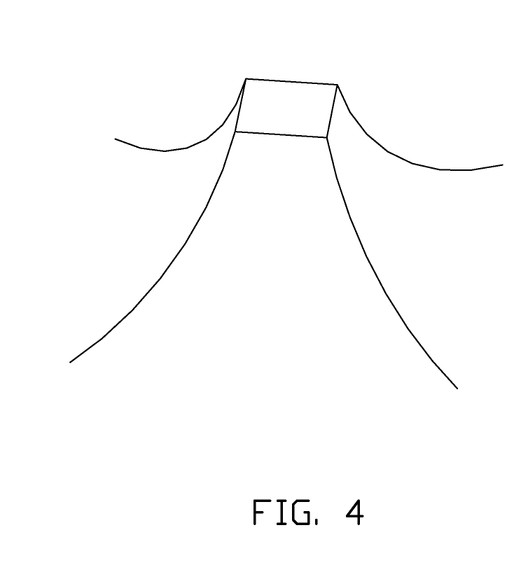

The positioning device 100 can be embodied as comprising multiple positioning sections 150, and the positioning sections can be also formed as circles. The positioning section 150 has a positioning flat top. The area of the positioning top can be adjusted by changing the mutual distance among the concaves. FIG. 4 is a perspective view of the positioning section 150 of FIG. 1, and the positioning top is embodied as a rectangle.

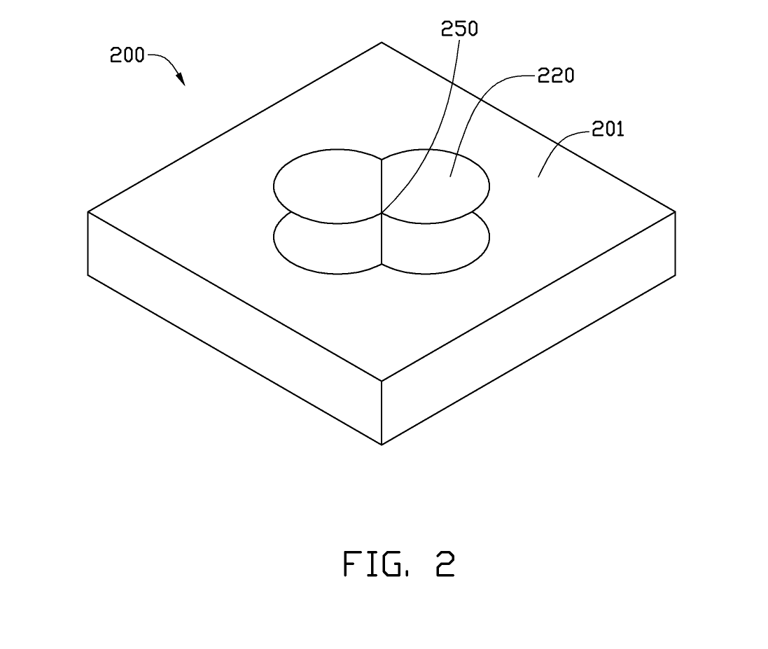

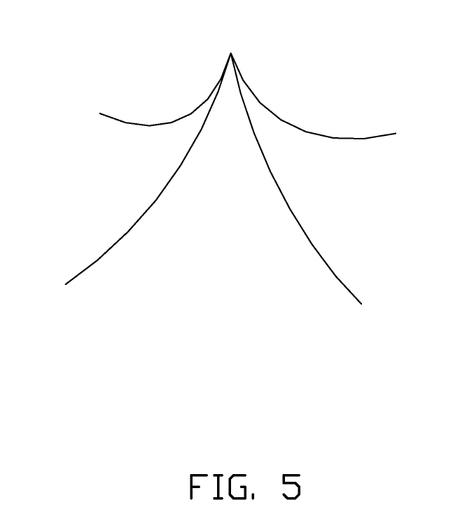

As shown in FIG. 2, the positioning device 200 comprises a plurality of combined concaves 220, provided in a predetermined location on a positioning surface 201. The concaves intersect at one point, which forms a positioning protrusion 250, e.g. a positioning tip. Compared to the positioning section 150, the positioning protrusion 250 is smaller and more easily recognized, and also improves accuracy of positioning. FIG. 5 is a perspective view of the positioning section 250 in FIG. 2.

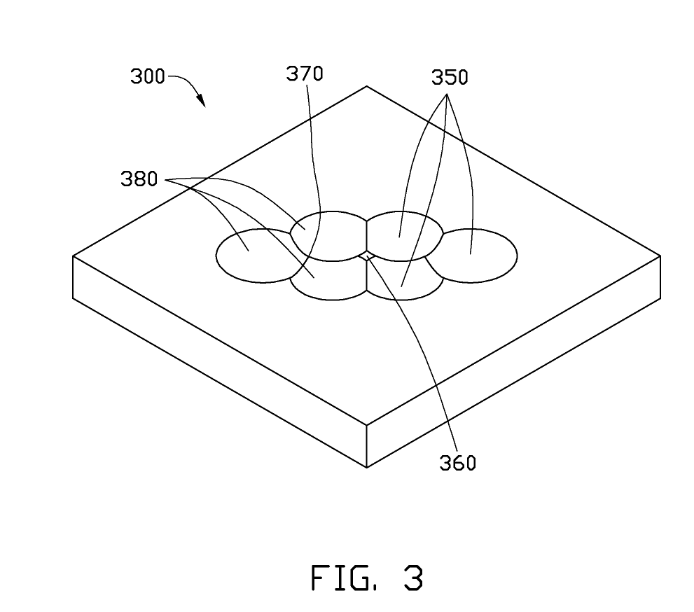

As shown in FIG. 3, the positioning device 300 comprises a plurality of combined first concaves 350 and a plurality of combined second concaves 380. The second concaves 380 overlap the respective first concaves 350. A first positioning tip 360 is formed among the overlapping portions of the combined first concaves 350 and the combined second concaves 380. A second positioning tip 370 is formed among the overlapping portions of the combined first concaves 380. The positioning device 300 comprises positioning sections with different area and shapes, and facilitates positioning for different sizes of workpieces.

The positioning device of the present application comprises concaves which boundaries overlap other boundaries adjacent thereto, forming a protrudent positioning section with high ease of recognition and improved positioning accuracy.

While the invention has been described by way of example and in terms of preferred embodiment, it is to be understood that the invention is not limited thereto. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A positioning device, comprising:
a positioning surface;
a plurality of combined concaves defined in the positioning surface, the concaves overlapping one another;
a positioning section formed among the overlapping portions of the concaves protruding from the positioning surface.

2. The positioning device as claimed in claim 1, wherein the positioning section includes a top flush with the positioning surface, and the shape of the top is substantially a polygon or a circle.

3. The positioning device as claimed in claim 1, wherein the positioning section is substantially a tip.

4. A positioning device, comprising:
a positioning surface;
a plurality of combined concaves defined in the positioning surface, the concaves overlapping one another; and
a plurality of positioning sections protruding from the positioning surface, each positioning section being surrounded by the neighboring concaves, the concaves symmetrically and radially arranged around the corresponding positioning section.

5. The positioning device as claimed in claim 4, wherein the positioning section includes a flat top, and the shape of the flat top is substantially a polygon or a circle.

6. The positioning device as claimed in claim 4, wherein the positioning section is substantially a tip.
